(19) United States
(12) Patent Application Publication
(10) Pub. No.: US 2023/0332301 A1
(43) Pub. Date: Oct. 19, 2023

(54) Method and Device for Electrolysis

(71) Applicant: Forschungszentrum Jülich GmbH, Julich (DE)

(72) Inventors: Maximilian Schalenbach, Köln (DE); Hermann Tempel, Kreuzau (DE); Hans Kungl, Heidelberg (DE); Rüdiger-A. Eichel, Jülich (DE)

(21) Appl. No.: 18/028,881

(22) PCT Filed: Dec. 13, 2021
(86) PCT No.: PCT/EP2021/085382

§ 371 Date: Mar. 28, 2023

(30) Foreign Application Priority Data
Dec. 16, 2020 (DE) 102020133773.6

(51) Int. Cl. C25B 1/04; C25B 9/19; C25B 15/08; C25B 15/031

(52) U.S. Cl. CPC C25B 1/04; C25B 9/19; C25B 15/083; C25B 15/031

(57) ABSTRACT

Method for electrolysis, wherein H2O is brought into contact with an anode, and a catholyte is brought into contact with a cathode, wherein the catholyte contains an auxiliary, wherein an electrical voltage is applied between the anode and the cathode such that oxygen is formed at the anode and the auxiliary is reduced at the cathode, and wherein protons and the reduced auxiliary are brought into contact with a catalyst such that the reduced auxiliary is oxidized and hydrogen is formed from the protons. By means of the auxiliary, the electrolysis can be carried out under low pressure, and hydrogen can still be obtained at high pressure. This facilitates the construction of the electrolytic cell and prevents an efficiency-reducing gas cross-permeation.

The invention relates to a method and to a device for electrolysis, in particular for the production of hydrogen.

Hydrogen is generally stored and transported under high pressure. For mobile applications, for example a pressure of 700 bar can be used. If hydrogen is produced by electrolysis, compression is therefore often required. However, mechanical compression is complicated, expensive and inefficient. Therefore, methods are known from the prior art by means of which hydrogen can already be produced under a pressure of, for example, 50 bar during the electrolysis. The outlay for subsequent compression of the hydrogen is thereby reduced. The construction of the electrolysis apparatuses becomes more cost-intensive as the pressure increases. In addition, the gas cross-permeation through the membrane of the electrolytic cell increases as the pressure increases, which reduces efficiency.

In the prior art, the gases produced during electrolysis, such as oxygen and hydrogen, are separated from the electrolyte in gas separators. The electrolyte can subsequently be reused.

The object of the present invention is that of producing hydrogen in a simple and efficient manner under high pressure, proceeding from the described prior art.

These objects are achieved by the method and a device according to the independent claims. Further advantageous embodiments are specified in the dependent claims. The features presented in the claims and in the description can be combined with one another in any technologically meaningful way.

According to the invention, a method for electrolysis is presented, in which H₂O is brought into contact with an anode, and a catholyte is brought into contact with a cathode, the catholyte containing a reversibly reducible and oxidizable auxiliary, an electrical voltage being applied between the anode and the cathode, such that oxygen is formed at the anode and the auxiliary is reduced at the cathode, and protons and the reduced auxiliary being brought into contact with a catalyst outside the electrochemical cells, in a reactor, such that the reduced auxiliary is oxidized and hydrogen is formed, under pressure, from the protons.

Hydrogen and oxygen can be produced by means of the described method, in particular in a gaseous state in each case. The hydrogen obtained can be used as an energy carrier, for example for driving motor vehicles. In this respect, the method can be regarded as a method for producing hydrogen under pressure. Oxygen is formed as a by-product in the process. In the method described, the hydrogen is not produced directly by electrolysis. Instead, electrolysis is performed using an auxiliary that is reduced during electrolysis. Subsequently, the hydrogen is obtained by a chemical reaction in which the auxiliary is also involved. In this respect, the hydrogen is thus obtained only indirectly by electrolysis. This takes place in a reactor which is preferably designed as a high-pressure reactor. The reactor is preferably designed to be able to withstand at least 20 bar. The reactor preferably represents a catalytic gas separator. In contrast to gas separators known from the prior art, a catalytic chemical reaction is also carried out in the catalytic gas separator, in addition to the gas separation. Hydrogen under high pressure can be obtained by the chemical reaction of the auxiliary downstream of the electrolysis. The electrolysis can be carried out at low pressure, for example at 5 bar or less. As a result, the problems of high-pressure electrolysis known from the prior art are avoided. By means of the described method, hydrogen can be obtained, for example at a pressure of 500 bar, without mechanical compression being necessary.

The electrolysis is carried out with H₂O and a catholyte. The H₂O can be present as liquid water and/or water vapor. A catholyte is to be understood as a substance which is brought into contact with the cathode during electrolysis. The catholyte is preferably a liquid. The catholyte contains an auxiliary. The auxiliary may be ions. For example, the catholyte can be water which contains the auxiliary ions. In this respect, the auxiliary is present as an aqueous solution. Alternatively, the auxiliary can be formed by molecules. The auxiliary is part of a redox pair which can be reversibly oxidized and reduced.

In this case, the term “reduction” refers, as is customary, to a chemical reaction in which one or more electrons are absorbed by an atom, ion or molecule. The reduced auxiliary is obtained by reduction from the auxiliary. If the auxiliary is formed by atoms or ions, the oxidation state of the auxiliary changes as a result of the reduction. If the auxiliary is formed by molecules, the reduction does not have to be accompanied by a change in the oxidation state. Nevertheless, it is said also in the case of molecules that the reduced auxiliary is obtained from the auxiliary by reduction—i.e., by electron uptake. Analogously, oxidation is defined as a chemical reaction in which one or more electrons are delivered from one atom, ion or molecule.

The H₂O can be oxidized by bringing it into contact with an anode as liquid water and/or gaseous water vapor. The catholyte is brought into contact with a cathode. This preferably takes place in that the water is rinsed along the anode or in that the catholyte is rinsed along the cathode. The anode and the cathode are preferably part of an electrolytic cell. This means that the anode and the cathode belong to the same electrolytic cell. The electrolytic cell preferably comprises IrO₂ as an anodic catalyst.

An electrical voltage is applied between the anode and the cathode in order to carry out the electrolysis. The magnitude of the electrical voltage is selected such that oxygen is formed at the anode and the auxiliary is reduced at the cathode.

In order to obtain hydrogen, protons and the auxiliary reduced in the electrolysis at the cathode are brought into contact with a catalyst. The catalyst is preferably formed of platinum. The catalyst is preferably arranged in a gas separator. The catalyst in the gas separator is not to be confused with the anodic catalyst. The protons may also have arisen during electrolysis and/or may originate from the catholyte. The protons can be contained in the catholyte from the start. The reduction of the auxiliary can increase the number of protons. The protons and the reduced auxiliary are preferably brought into contact with the catalyst arranged in the gas separator in that the catholyte, together with the reduced auxiliary and the protons, is guided into a container (which can be designed, in particular, as a catalytic gas separator) which is equipped with a catalyst. Thus in particular the ions of the reduced auxiliary and the protons can be present in aqueous solution and as such can be brought into contact with the catalyst. In the case of the electrocatalytic process which takes place at the catalyst in the gas separator, the catalyst serves simultaneously as an anode for the oxidation of the reduced auxiliary and as a cathode for the reduction of the protons. The fact that the reduced auxiliary is oxidized means that the auxiliary is again obtained from the reduced auxiliary. The previously reduced auxiliary is oxidized again. The auxiliary oxidized by the chemical reaction at the catalyst can be reused and reduced again by electrolysis. Preferably, the auxiliary is used in a circuit, the auxiliary being alternately reduced by electrolysis and recovered by oxidation at the catalyst in the gas separator. The protons can be converted to hydrogen by means of the electrons released by the oxidation of the reduced auxiliary. The auxiliary and the material of the catalyst are preferably selected such that the reaction at the catalyst proceeds spontaneously.

The catalyst in the gas separator is preferably applied to a catalyst bed which can be formed, for example, of porous ceramic, a carbon fleece or a metal lattice, for example of silver. The catalyst is preferably arranged in such a way that it is in contact with the liquid catholyte during operation. Gaseous hydrogen can be formed at the catalyst and can rise as gas bubbles in the liquid catholyte. As a result, the catholyte can be mixed, such that fresh catholyte continuously reaches the catalyst. This can be further enhanced by mounting the catalyst such that the catalyst is moved, in particular rotated, through the rising gas bubbles.

In a preferred embodiment of the method, the auxiliary and the reduced auxiliary form a redox pair having a negative standard electrochemical potential. This is particularly preferred when the catholyte has a pH of 2 or less.

In this embodiment, the auxiliary may be referred to as non-noble as hydrogen. The redox reaction with the reduced auxiliary and the auxiliary, on the one hand, and the protons and the hydrogen, on the other hand, can therefore proceed such that the auxiliary and the hydrogen are formed.

In a further preferred embodiment of the method, the auxiliary is V³⁺ and the reduced auxiliary is V²⁺.

In this embodiment, the auxiliary is formed by ions. VV³⁺ are triply positive ions of vanadium. They can be reduced to VV²⁺, that is to say to doubly positive vanadium ions. The redox pair VV³⁺/V²⁺ has a standard electrochemical potential of −0.25 V.

In this embodiment, the following chemical reactions take place in the electrolytic cell:

2H₂O→4H⁺+O₂+4e⁻ (1)

V³⁺+e⁻→V²⁺ (2)

The reaction according to equation (1) takes place at the anode, as a result of which H₂O is converted to oxygen and protons, the protons migrating to the cathode. The oxygen can be formed in a gaseous state. The reaction according to equation (2) takes place at the cathode, as a result of which V³⁺, as the auxiliary, is reduced to V²⁺. The following overall reaction thus results for the electrolysis:

2H₂O+4V³⁺→4H⁺+O₂+4V²⁺ (3)

In addition, the following reactions take place in the catalytic gas separator:

V²⁺→V³⁺+e⁻ (4)

2H⁺+2e⁻→H₂ (5)

The reaction according to equation (5) takes place at the catalyst, preferably in the gas separator. The reaction according to equation (4) can likewise take place at the catalyst, but this is not necessarily the case—it can also take place on an electrically conductive material which is in contact with the catalyst, for example a carbon carrier.

This results in the following overall reaction from the reactions according to equations (4) and (5):

2V²⁺+2H⁺→2V³⁺+H₂ (6)

In this respect, hydrogen is obtained from the protons and by the change in the oxidation state of the auxiliary.

In a further preferred embodiment of the method, the auxiliary is suitable for reversible hydrogen uptake and hydrogen release. This is the case in particular in the preferred situation in which the auxiliary is formed by quinones.

The group of quinones includes organic compounds of crossed cyclically conjugated diketones. The auxiliary is preferably formed by hydroxyquinones.

The reduction at the cathode takes place, in this case, according to the following equation:

Auxiliary+2e⁻+2H₂O→2OH⁻+Auxiliary−H₂ (7)

In this embodiment, in particular any substance comprising quinone molecules, with which a reaction according to equation (7) is possible, can be considered as auxiliary. According to equation (7), these do not change their oxidation state, as would be the case with ions. Nevertheless, the auxiliary comprising the absorbed hydrogen (“auxiliary-H₂”) is referred to as the “reduced auxiliary” because it has resulted from the auxiliary by way of the reduction according to equation (7).

In a further preferred embodiment of the method, the anode is arranged in an anode chamber of an electrolytic cell, the cathode is arranged in a cathode chamber of the electrolytic cell, and the catalyst is arranged in a gas separator connected to the cathode chamber.

The catholyte, together with the reduced auxiliary and the protons, is preferably present in the cathode chamber in liquid state. If the reduced auxiliary is ions, for example V²⁺, these ions can be present together with the protons as an aqueous solution. The catholyte together with the reduced auxiliary and the protons can thus be a liquid, which can be guided from the cathode chamber into the gas separator. The hydrogen can be formed as described, in particular in the gaseous state, at the catalyst in the gas separator. The hydrogen thus formed can be separated in the gas separator. Thus, the gaseous hydrogen can be discharged, for example via a gas outlet at the upper side of the gas separator, while the liquid catholyte, together with the recovered auxiliary, can be removed at a liquid outlet arranged at the lower side of the gas separator, for example in order to be fed back to the cathode chamber. Furthermore, the gas separator preferably has a feed for the catholyte. The feed can be arranged at any point in the gas separator.

For thermodynamic reasons, the achievable pressure of the hydrogen can be higher if the temperature in the gas separator is low. It is therefore preferred for the gas separator to have a cooling means. The cooling means can use, for example, ambient air and/or cooling water for cooling.

In a further preferred embodiment of the method, the anode chamber and the cathode chamber are separated from one another by a membrane which is permeable to protons, wherein protons are also formed at the anode by applying the electrical voltage between the anode and the cathode.

Alternatively or in addition to protons which are already contained in the catholyte, protons can be formed at the anode, from the H₂O. These can pass through the membrane from the anode chamber into the cathode chamber and, for example, be guided from there, together with the catholyte, into the gas separator.

In a further preferred embodiment of the method, the protons and the reduced auxiliary are introduced continuously into the gas separator, and gaseous hydrogen is withdrawn continuously from the gas separator.

Preferably, the gas separator comprises a pressure actuator at the gas outlet, via which actuator the hydrogen can be removed at a predetermined pressure. The predetermined pressure is preferably in the range between 300 and 600 bar. The catholyte together with the reduced auxiliary and the protons can, for example, be pumped into the gas separator via a pump. This makes it possible for the electrolysis to be operated at low pressure and to nevertheless produce the hydrogen at high pressure. The problems of high-pressure electrolysis known from the prior art are thus avoided.

In a further preferred embodiment of the method, the protons and the reduced auxiliary are introduced discontinuously into the gas separator, and gaseous hydrogen is withdrawn discontinuously from the gas separator.

In this embodiment, the following steps can be carried out:
a) introducing the catholyte, together with the reduced auxiliary and the protons, into the gas separator;
b) closing the gas separator;
c) removing the hydrogen formed in the gas separator, and the catholyte, together with the recovered auxiliary, after the pressure in the gas separator has reached a predetermined limit value.

Step a) can take place under the pressure prevailing in the cathode chamber of the electrolytic cell. This pressure is preferably in the range from 0.5 to 5 bar. In step b), the gas separator is preferably completely closed, such that the pressure in the gas separator increases due to the gaseous hydrogen formed at the catalyst. Thus, a connection between the gas separator and the cathode chamber, and the gas outlet and the liquid outlet of the gas separator, are preferably closed, for example by a respective valve. In step c), the hydrogen, on the one hand, and the catholyte together with the recovered auxiliary, on the other hand, can be removed simultaneously or successively in any sequence. Steps a) to c) are preferably carried out cyclically.

In a further preferred embodiment of the method, the protons and the reduced auxiliary are introduced into the gas separator in part continuously and in part discontinuously, and gaseous hydrogen is removed from the gas separator in part continuously and in part discontinuously.

This embodiment is a mixture of the two embodiments described above. It can be achieved, for example, by introducing the catholyte, together with the reduced auxiliary and the protons, into the gas separator with alternately changing pressure, and by removing the resulting hydrogen from the gas separator with alternately changing pressure. In this case, the catholyte, together with the reduced auxiliary and the protons, is introduced into the gas separator in part continuously if a basic flow is permanently present. In addition, the catholyte, together with the reduced auxiliary and the protons, is introduced discontinuously into the gas separator if the flow is temporarily greater than the basic flow, that is to say can be interpreted as the sum of the basic flow and an additional flow. The same applies for the removal of the hydrogen. Preferably, the introduction of the catholyte, together with the reduced auxiliary and the protons, and the removal of the resulting hydrogen, are synchronized with one another.

In a further preferred embodiment of the method, the catholyte has a pH of less than 2, in particular of less than 0.5.

A low pH means that protons are present in the catholyte. They can contribute to forming hydrogen at the catalyst in the gas separator. It is particularly preferable for the catholyte to have a pH of 0 or less. The specification of the pH of the catholyte relates to how the catholyte is present before the start of the electrolysis.

A further aspect of the invention provides a method for electrolysis, H₂O being brought into contact with an anode of a first electrolytic cell, and a first catholyte being brought into contact with a cathode of the first electrolytic cell, the first catholyte containing a first auxiliary, an electrical voltage being applied between the anode and the cathode of the first electrolytic cell, such that oxygen is formed at the anode of the first electrolytic cell, and the first auxiliary being reduced at the cathode of the first electrolytic cell, the first catholyte, together with the first reduced auxiliary, being brought into contact with an anode of a second electrolytic cell, and a second catholyte being brought into contact with a cathode of the second electrolytic cell, the second catholyte containing a second auxiliary, an electrical voltage being applied between the anode and the cathode of the second electrolytic cell, such that the reduced first auxiliary is oxidized at the anode of the second electrolytic cell, and the second auxiliary is reduced at the cathode of the second electrolytic cell, and protons and the reduced second auxiliary being reacted with one another such that the reduced second auxiliary is oxidized and hydrogen is formed from the protons.

The described advantages and features of the previously described method are applicable and transferable to the method described here, and vice versa.

The method described herein is based on the same principle as the method described above. In both cases, H₂O is brought into contact with an anode (here of the first electrolytic cell), and a catholyte (here the second catholyte) is brought into contact with a cathode (here of the second electrolytic cell). The (second) catholyte contains an auxiliary (here the second auxiliary). By applying an electrical voltage, oxygen is formed at the anode (here of the first electrolytic cell) and an auxiliary (here the second auxiliary) is reduced at the cathode (here of the second electrolytic cell). Protons and the reduced (second) auxiliary are reacted with one another, such that the reduced (second) auxiliary is oxidized and hydrogen is formed from the protons. This reaction is preferably carried out using a catalyst. It is therefore preferable for protons and the reduced auxiliary to be brought into contact with a catalyst such that the reduced auxiliary is oxidized and hydrogen is formed from the protons.

The difference between the method described herein and the method described above is that the production of the hydrogen is not only carried out using one auxiliary, but using two auxiliaries. To this end, in the method described herein, a further pair of cathode and anode is connected between the process of the method described above. A respective electrical voltage is applied between the anode and the cathode of the first electrolytic cell and between the anode and the cathode of the second electrolytic cell. This can take place in that the anode of the first electrolytic cell and the cathode of the second electrolytic cell are connected to a voltage source, and in that the cathode of the first electrolytic cell and the anode of the second electrolytic cell are electrically conductively connected to one another.

The first auxiliary is preferably the second auxiliary in doubly oxidized form. This is described below by way of example for the case of vanadium. Thus, V⁵⁺ can be used as the first auxiliary, and V³⁺ can be used as the second auxiliary. In this case, the following chemical reactions take place in the first electrolytic cell:

2H₂O→4H⁺+O₂+4e⁻ (8)

V⁵⁺+e⁻→V⁴⁺ (9)

The reaction according to equation (8) takes place at the anode of the first electrolytic cell, as a result of which H₂O is converted to oxygen and protons (identical to equation (1) described above). The oxygen can be formed in a gaseous state. The reaction according to equation (9) takes place at the cathode of the first electrolytic cell, as a result of which V⁵⁺, as first auxiliary, is reduced to V⁴⁺. The following overall reaction thus results for the electrolysis in the first electrolytic cell:

2H₂O+4V⁵⁺→4H⁺+O₂+4V⁴⁺ (10)

In the second electrolysis, the following chemical reactions take place:

V⁴⁺→V⁵⁺+e⁻ (11)

V³⁺+e⁻→V²⁺ (12)

The reaction according to equation (11) takes place at the anode of the second electrolytic cell. By means of this reaction, the reduced first auxiliary V⁴⁺ is oxidized, as a result of which the first auxiliary V⁵⁺ is recovered. The recovered first auxiliary V⁵⁺ can again be brought into contact with the cathode of the first electrolytic cell. In particular, the first catholyte can be rinsed alternately, in a circuit, along the cathode of the first electrolytic cell and along the anode of the second electrolytic cell. The reaction according to equation (12) takes place at the cathode of the second electrolytic cell, as a result of which V³⁺, as the second auxiliary, is reduced to V²⁺ (identical to equation (2) described above). The following overall reaction thus results for the electrolysis in the second electrolytic cell:

V⁴⁺+V³⁺→V⁵⁺+V²⁺ (13)

The reactions described above as equations (4) to (6) take place at the catalyst. This takes place in a manner identical to the previously described method.

The method described herein has the practical advantage that aging phenomena on the electrolytic cells are particularly low. This is the case, in particular, when the first electrolytic cell comprises IrO₂ as the anodic catalyst (which is not to be confused with the catalyst used for hydrogen production). Thus, the iridium can dissolve over the operating time of the electrolytic cell and pass through the membrane of the electrolytic cell in the form of ions. As a result, the iridium can accumulate on the cathode. As the iridium deposition on the cathode increases, the hydrogen evolution of the reduction of the auxiliary is favored. The hydrogen would thus already be formed at the cathode, as a result of which the described advantages of separation of electrolysis and hydrogen production could no longer be achieved. This type of aging of the electrolytic cell can be prevented by the method described herein. This is because the iridium accumulates predominantly on the cathode of the first electrolytic cell. Due to the standard electrochemical potential of the first auxiliary, no hydrogen can be formed at the cathode of the first electrolytic cell. The first auxiliary is preferably selected accordingly. Thus, it is particularly preferable for the first auxiliary and the reduced first auxiliary to form a redox pair having a standard electrochemical potential of more than 0 V. The redox pair V⁵⁺/V⁴⁺ has, for example, a standard electrochemical potential of 1 V.

A further aspect of the invention provides a device for electrolysis by means of one of the described methods. The device comprises an electrolytic cell comprising an anode chamber and an anode arranged therein, a cathode chamber and a cathode arranged therein, and a gas separator which is connected to the cathode chamber.

The described advantages and features of the two methods described are applicable and transferable to the device, and vice versa. The two described methods are preferably carried out using the described device. If the device is to be used for the last-described method, the device comprises two electrolytic cells, each of which has an anode chamber and an anode arranged therein, and a cathode chamber and a cathode arranged therein. The gas separator is connected to the cathode chamber of the second electrolytic cell.

The invention is explained in more detail below with reference to the drawings. The drawings show particularly preferred embodiments, although the invention is not limited to these. The drawings and the proportions shown therein are only schematic. In the drawings:

FIG. 1 shows a first embodiment of a device according to the invention for electrolysis;

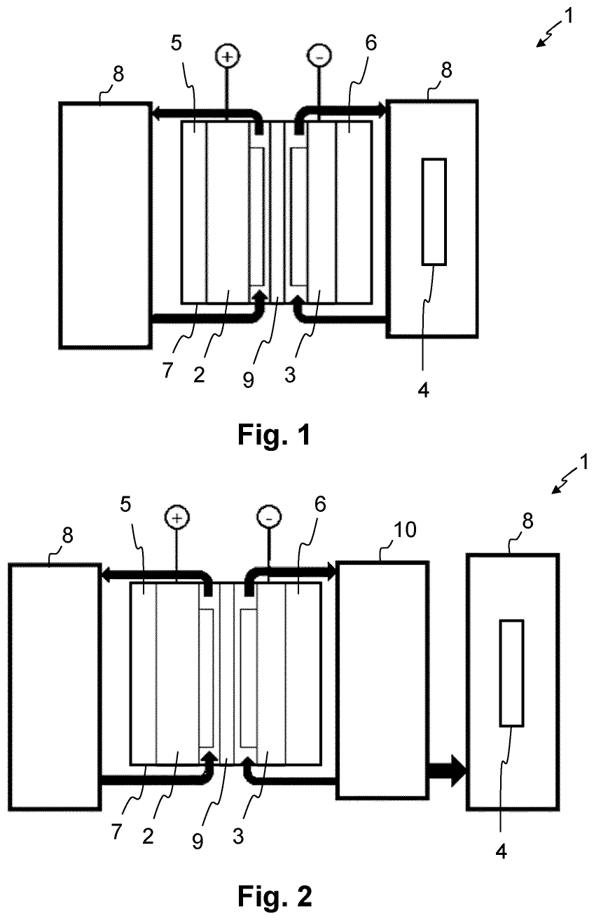

FIG. 2 shows a second embodiment of a device according to the invention for electrolysis;

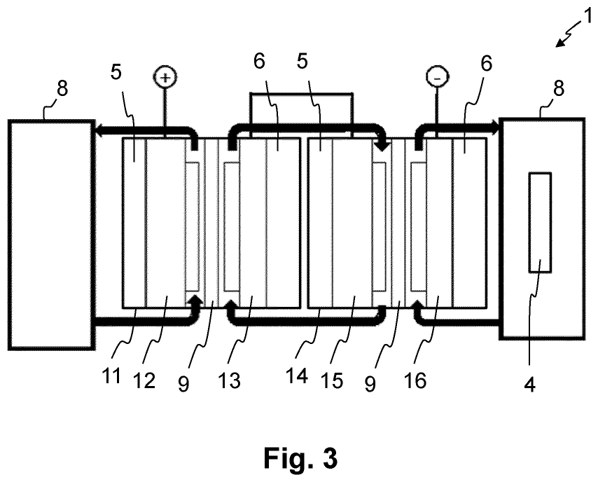

FIG. 3 shows a third embodiment of a device according to the invention for electrolysis.

FIG. 1 shows a first embodiment of a device 1 for electrolysis. The device 1 comprises an electrolytic cell 7. The electrolytic cell 7 comprises an anode chamber 5 having an anode 2 arranged therein, and a cathode chamber 6 having a cathode 3 arranged therein. The anode chamber 5 and the cathode chamber 6 are separated from one another by a membrane 9. The anode 2 and the cathode 3 are each connected to a voltage source. Furthermore, the device 1 comprises a gas separator 8 for the anode 2 and the cathode 3, in each case. A catalyst 4 made of platinum is arranged in the cathodic gas separator 8.

The device 1 can be used to produce oxygen and hydrogen. To this end, H₂O is brought into contact with the anode 2 by introducing water into the anode chamber 5. A catholyte is brought into contact with the cathode 3 by introducing the catholyte into the cathode chamber 6. The catholyte contains V³⁺ as an auxiliary. An electrical voltage is applied between the anode 2 and the cathode 3, via the voltage source. As a result, gaseous oxygen and protons are formed at the anode 2; the auxiliary is reduced at the cathode 3 to V²⁺. The protons formed on the anode 2 can pass through the membrane 9 into the cathode chamber 6. In addition, the catholyte has a pH of less than 2. By passing the catholyte into the cathodic gas separator 8, protons and the reduced auxiliary, V²⁺, can thus be brought into contact with the catalyst 4. As a result, the reduced auxiliary, V²⁺, is oxidized to V³⁺, hydrogen is formed from the protons.

In the embodiment according to FIG. 1, the catholyte, together with the protons and the reduced auxiliary V²⁺, can be continuously introduced into the cathodic gas separator 8. Gaseous hydrogen can thereby be continuously removed from the gas separator 8.

FIG. 2 shows a second embodiment of a device 1 for electrolysis. This device 1 is described only to the extent that it deviates from the embodiment according to FIG. 1. Thus, the device 1 according to FIG. 2 additionally comprises a buffer container 10. This makes it possible to introduce the protons and the reduced auxiliary V²⁺ discontinuously into the gas separator 8, and to withdraw the gaseous hydrogen discontinuously from the gas separator 8

FIG. 3 shows a third embodiment of a device 1 according to the invention for electrolysis. The device 1 comprises a first electrolytic cell 11 and a second electrolytic cell 14. The first electrolytic cell 11 and the second electrolytic cell 14 each comprise an anode chamber 5 having an anode 12, 15 arranged therein, and a cathode chamber 6 having a cathode 13, 16 arranged therein. The anode chamber 5 and the cathode chamber 6 are each separated from one another by a membrane 9. The anode 12 of the first electrolytic cell 11 and the cathode 16 of the second electrolytic cell 14 are each connected to a voltage source. The cathode 13 of the first electrolytic cell 11 and the anode 15 of the second electrolytic cell 14 are electrically conductively connected to one another. Furthermore, the device 1 comprises a gas separator 8 in each case for the anode 12 of the first electrolytic cell 11 and the cathode 16 of the second electrolytic cell 14. A catalyst 4 made of platinum is arranged in the cathodic gas separator 8. Analogously to FIG. 2, a buffer container 10 could also be connected between the second electrolytic cell 14 and the cathodic gas separator 8.

The device 1 according to FIG. 3 can also be used to produce oxygen and hydrogen. To this end, H₂O is brought into contact with the anode 12 of the first electrolytic cell 11 by introducing water into the anode chamber 5 of the first electrolytic cell 11. A first catholyte is brought into contact with the cathode 13 of the first electrolytic cell 11 by introducing the first catholyte into the cathode chamber 6 of the first electrolytic cell 11. The first catholyte contains V⁵⁺ as a first auxiliary. An electrical voltage can be applied between the anode 12 of the first electrolytic cell 11 and the cathode 16 of the second electrolytic cell 14, via the voltage source. This also results in an electrical voltage between the anode 12 and the cathode 13 of the first electrolytic cell 11. Gaseous oxygen and protons are thereby formed at the anode 12 of the first electrolytic cell 11. The first auxiliary is reduced, at the cathode 13 of the first electrolytic cell 11, to V⁴⁺.

The first catholyte, together with the first reduced auxiliary, is brought into contact with the anode 15 of the second electrolytic cell 14; a second catholyte is brought into contact with the cathode 16 of the second electrolytic cell 14. The second catholyte contains V³⁺ as a second auxiliary. The electrical voltage applied by the voltage source also results in an electrical voltage between the anode 15 and the cathode 16 of the second electrolytic cell 14. As a result, the reduced first auxiliary is oxidized at the anode 15 of the second electrolytic cell 14, and the second auxiliary is reduced at the cathode 16 of the second electrolytic cell 14. The remaining process sequence is as in the embodiments according to FIG. 1 or 2.

By means of the auxiliary, the electrolysis can be carried out under low pressure, and hydrogen can still be obtained at high pressure. This facilitates the construction of the electrolytic cell and prevents an efficiency-reducing gas cross-permeation.

### LIST OF REFERENCE SIGNS

1 device
2 anode
3 cathode
4 catalyst
5 anode chamber
6 cathode chamber
7 electrolyte cell
8 gas separator
9 membrane
10 buffer container
11 first electrolytic cell
12 anode of the first electrolytic cell
13 cathode of the first electrolytic cell
14 second electrolytic cell
15 anode of the second electrolytic cell
16 cathode of the second electrolytic cell

1. A method for electrolysis, wherein H₂O is brought into contact with an anode, and a catholyte is brought into contact with a cathode, wherein the catholyte contains an auxiliary, wherein an electrical voltage is applied between the anode and the cathode such that oxygen is formed at the anode and the auxiliary is reduced at the cathode, and wherein protons and the reduced auxiliary are brought into contact with a catalyst such that the reduced auxiliary is oxidized and hydrogen is formed from the protons.

2. The method according to claim 1, wherein the auxiliary and the reduced auxiliary form a redox pair having a negative standard electrochemical potential.

3. The method according to claim 1, wherein the auxiliary is V³⁺, and the reduced auxiliary is V²⁺.

4. The method according to claim 1, wherein the anode is arranged in an anode chamber of an electrolytic cell, the cathode is arranged in a cathode chamber of the electrolytic cell, and the catalyst is arranged in a gas separator connected to the cathode chamber.

5. The method according to claim 4, wherein the anode chamber and the cathode chamber are separated from one another by a membrane permeable to protons, and wherein protons are also formed at the anode by applying the electrical voltage between the anode and the cathode.

6. The method according to claim 4, wherein the protons and the reduced auxiliary are introduced continuously into the gas separator, and gaseous hydrogen is withdrawn continuously from the gas separator.

7. The method according to claim 4, wherein the protons and the reduced auxiliary are introduced discontinuously into the gas separator, and gaseous hydrogen is withdrawn discontinuously from the gas separator.

8. The method according to claim 1, wherein the catholyte has a pH of less than 2.

9. The method for electrolysis, wherein H₂O is brought into contact with an anode of a first electrolytic cell, and a first catholyte is brought into contact with a cathode of the first electrolytic cell, wherein the first catholyte contains a first auxiliary, wherein an electrical voltage is applied between the anode and the cathode of the first electrolytic cell such that oxygen is formed at the anode of the first electrolytic cell, and the first auxiliary is reduced at the cathode of the first electrolytic cell, wherein the first catholyte, together with the first reduced auxiliary, is brought into contact with an anode of a second electrolytic cell, and a second catholyte is brought into contact with a cathode of the second electrolytic cell, wherein the second catholyte contains a second auxiliary, wherein an electrical voltage is applied between the anode and the cathode of the second electrolytic cell such that the reduced first auxiliary is oxidized at the anode of the second electrolytic cell, and the second auxiliary is reduced at the cathode of the second electrolytic cell, and wherein protons and the reduced second auxiliary are reacted with one another such that the reduced second auxiliary is oxidized and hydrogen is formed from the protons.

10. A device for electrolysis by means of a method according to claim 9, comprising an electrolytic cell having an anode chamber and an anode arranged therein, a cathode chamber and a cathode arranged therein, and a gas separator which is connected to the cathode chamber.
